(19) United States
(12) Patent Application Publication
(10) Pub. No.: US 2009/0266388 A1
(43) Pub. Date: Oct. 29, 2009

(54) FLEXIBLE SHOWERING DEVICE FOR A PULP AND PAPER MAKING MACHINE

(75) Inventor: Rejean Legault, LaSalle (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: ACCESSOIRES POUR PATES ET PAPIERS EKIP LTEE, LaSalle (CA)

(21) Appl. No.: 12/110,612

(22) Filed: Apr. 28, 2008

(51) Int. Cl. B08B 3/00; B05B 15/00; B05B 1/00

(52) U.S. Cl. 134/172; 239/547; 239/589

(57) ABSTRACT

A hose for use in a showering device and a showering device for cleaning, with a liquid, a machine used in the pulp and paper industry are described. The hose has a flexible wall for circulating the liquid and comprises a plurality of nozzles attached to the wall. The nozzles are spaced apart from each other and substantially aligned with each other along a longitudinal axis of the hose. The showering device comprises the hose and two connectors, one at each extremity of the hose.

### FIELD OF THE INVENTION

The present invention generally relates to the field of machinery. used in the pulp and paper industry. More specifically, the invention relates to a flexible showering device for a pulp and paper making machine.

### BACKGROUND OF THE INVENTION

Numerous showering devices are used in a papermaking machine to keep the surfaces of mesh belts of conveyors free from paper fibers and other contaminants. These known showering devices are generally comprised of a series of nozzles mounted on pipes that are oriented across the width of the conveyor belt. Typically, the nozzles are mounted on a metal pipe capable of accommodating high water pressures (from between 40 and 150 psi for lubricating showers, up to between 300 and 650 psi for needle showers). The nozzles are generally spaced at approximately 3, 6 or up to 12 inches between centers. The nozzles are typically threaded to the pipe to allow for replacement.

In use, the nozzles spray cleaning liquid such as water and various chemicals onto the mesh belts of the papermaking machine to remove paper fibers and/or contaminants. If one or more of these shower nozzles becomes blocked, it is no longer able to provide the desired beneficial effects at that particular location. This may lead to degradation of belt properties, which can result in marking on the sheet of paper being formed thereon.

To correct this situation, the blocked nozzles in these prior art showering devices must be removed to be replaced or cleaned. Generally, the papermaking machine needs to be shut down, as the shower pipe must be disconnected from the water supply and then removed. Furthermore, these pipes are heavy, being made of a metallic material (most often stainless steel) thereby often requiring two people for performing the removal and the use of a overhead crane. Furthermore, because the shower pipe slides in an elongated cylindrical support, the removal is a very encumbering maneuver, the shower pipe having to slide all the way in or out of its support. Because of this, a clearance area is required around the papermaking machine, wasting precious plant area.

There is therefore a need for a showering device that is both lighter and less encumbering than showering devices of the prior art.

### SUMMARY OF THE INVENTION

It is an object of the present invention to provide a showering device for a papermaking machine that overcomes or mitigates one or more disadvantages of known showering devices, or at least provides a useful alternative.

The invention provides the advantages of easing the replacement of the showering device in the papermaking machine by being of a lighter weight and less encumbering than showering devices of the prior art. Furthermore, because of its lighter weight, it may be possible to perform the removal of the showering device of the present invention from the papermaking machine using less people and without the help of heavy duty lifting equipment.

In accordance with an embodiment of the present invention, there is provided a hose for a showering device for cleaning a papermaking machine with a liquid. The hose comprises a flexible wall for circulating the liquid and a plurality of nozzles. The nozzles are attached to the wall, spaced apart from each other, and are substantially aligned with each other along a longitudinal axis of the hose. The nozzles connect an interior side of the wall to an exterior side and allow spraying the liquid.

In accordance with another embodiment of the invention, there is provided a showering device for cleaning a papermaking machine with a liquid. The showering device comprises the hose described here above and two connectors, each one of the connectors being placed at a different extremity of the hose.

Optionally, the showering device may comprise two locking mechanisms, each locking mechanism being located proximate a respective one of the two connectors. Optionally, at least one of the two locking mechanisms is removable from the connector.

### BRIEF DESCRIPTION OF DRAWINGS

These and other features of the present invention will become more apparent from the following description in which reference is made to the appended drawings wherein:

FIG. 1 is a schematic perspective view of a portion of a papermaking machine having a conveyer belt and a showering device in accordance with an embodiment of the present invention;

FIG. 2 is a perspective view, partly cut away, of the showering device of FIG. 1;

FIG. 3 is a perspective view of the showering device of FIG. 1 inserted in its support;

FIG. 4 is a perspective view of the showering device of FIG. 1 in a rolled-up position;

FIG. 5 is a cross-sectional view of a hose of the showering device of FIG. 1 at a nozzle location;

FIG. 6 is cross-sectional view of a nozzle in accordance with another embodiment of the present invention.

### DETAILED DESCRIPTION OF THE INVENTION

The present invention relates to a showering device for cleaning with a liquid a component of a machine used in the pulp and paper industry. This type of machines may be used either in the manufacturing of pulp or paper. They may be used in the production of a variety of products which, at one step of their production, are in the form of a paste or of a wet mat. Furthermore, these machines may be used at different steps of production. For instance, in the manufacturing of paper, these machines could be used at the forming step, the pressing step or the drying step. As a non-limiting example, the following description will refer to a machine used in the production of paper.

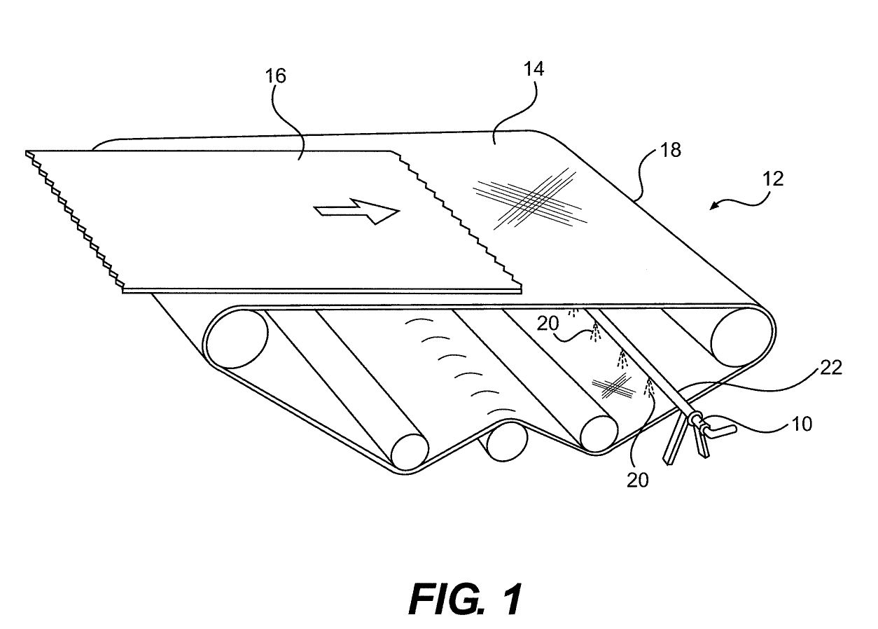

Referring to FIG. 1, there is depicted a showering device 10 installed within a conveyor 12 of a papermaking machine. The conveyor 12 uses a belt 14 that is typically made of a mesh on which paper pulp 16 is carried at high speed. Depending where the conveyor 12 is used in the production line, the belt 14 could either be a forming fabric, a press felt or a dryer fabric. The paper pulp 16 gets off the belt 14 at an output end 18 of the conveyor 12. As the paper pulp 16 is unloaded, the belt 14 needs to be cleaned so that paper paste remains that could have got stuck in the mesh belt 14 are removed before the unloaded section of the belt 14 returns to carry more of the continuous load of paper pulp 16. The cleaning liquid is circulated inside the showering device 10, which is installed transversally to the direction of travel of the belt 14 allowing cleaning the whole width of the belt 14. Cleaning the belt 14 is achieved by spraying jets 20 of the cleaning liquid, typically made with water or a mix of water and cleaning agent, onto the belt 14 so that paper paste remains are ejected from the belt surface. The showering device 10 is supported in a slotted support 22, the longitudinal slot making room for the jets 20. The support may be of a fixed type or of an oscillating type.

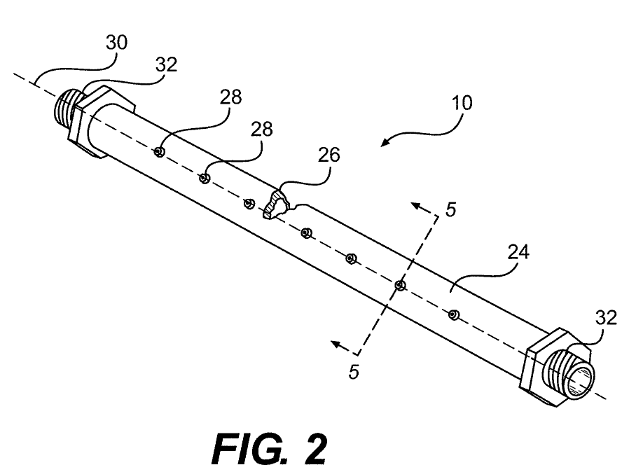

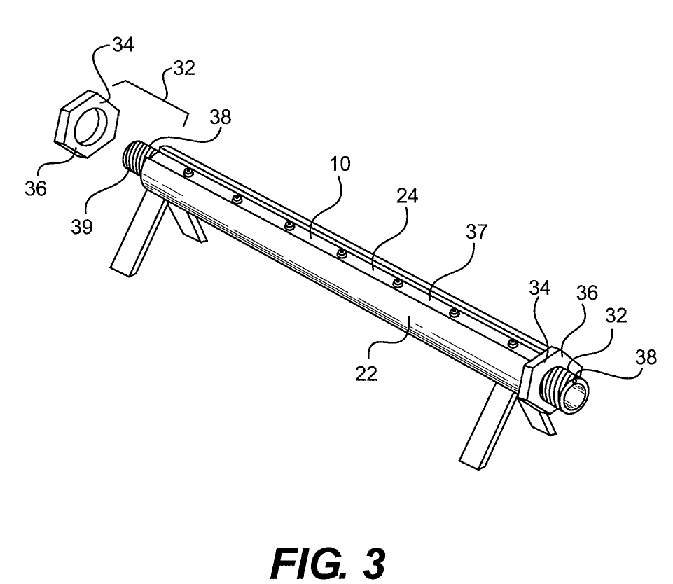

Turning now to FIG. 2, there is show details of the showering device 10. The showering device 10 is made of a hose 24 having a flexible wall 26 to which are affixed a plurality of nozzles 28. The nozzles 28 are affixed to the wall 26 in substantial alignment with respect to each other along a longitudinal axis 30 of the hose 24. The nozzles 28 need not be accurately aligned with one another, but need only be sufficiently aligned so as to fit within a slot 37 of the support 22 (best shown in FIG. 3, now concurrently referred to). The nozzles 28 are spaced apart, allowing spraying the cleaning liquid circulating inside the hose 24 onto the whole belt width. The spacing of the nozzles 28 typically ranges from 3 to 24 inches. The showering device 10 uses two connectors 32, each one at a different extremity of the hose 24 to connect the showering device 10 to a source of cleaning liquid. The connectors 32 may be of many types known in the art, such as of a threaded type or of a quick-connect type.

Optionally, the connectors 32 may include a locking mechanism 34 that helps in keeping the hose 24 longitudinally in place in the support 22. This locking mechanism 34 may take different aspects and may be as simple as a nut 36 that is inserted over a threaded portion 39 of the connector 32. It will be apparent that if a different locking mechanism 34 is used that does not involve threads, connectors 32 may be dispensed from having threads. At least one of the locking mechanisms 34 is removable from its connector 32 to ease insertion of the showering device 10 in the support 22. As shown in FIG. 3, the showering device 10 is inserted in its support 22 from one end, here the proximal end. In order to be able to insert the hose 24 in the support 22, the distal locking mechanism 34 on the distal connector 32 has been momentarily removed to allow insertion of the hose 24. At the proximal end of the hose 24, the proximal locking mechanism 34 on the proximal connector 32 may be left in place.

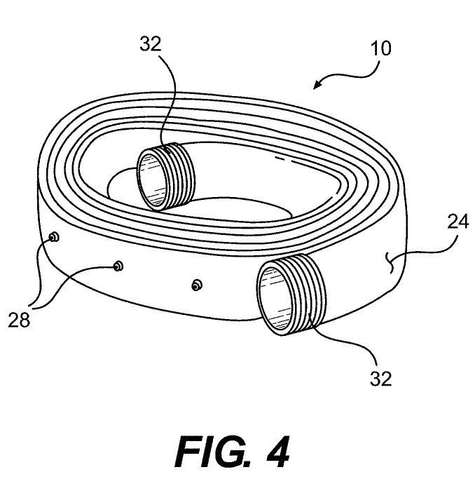

Typically, the support 22 is made of stainless steel. The support 22 is slotted, the nozzles 28 of the showering device 10 being aligned in a slot 37 so as to properly spray on the belt 14 (not shown in this figure). Normally, the hose 24 is stiff enough that it can be pushed in the support 22 from its proximal end. If a softer material is used for the hose 24, the hose may be pulled form its distal end into the support 22. Since access to a mid portion of the support 22 is at best very cumbersome, and generally not accessible at all, it is possible to properly align the nozzles 28 in the slot 37 by tensioning the hose 24 and rotating the showering device 10. To further help with aligning the showering device 10 in its support 22, at least one of the two connectors 32 is provided with an alignment mechanism 38 that is aligned with the line of nozzles 28. This alignment mechanism may be as simple as a mark (as shown on the proximal connector 32) or can be other suitable alignment means such as a boss on the connectors 32 that aligns in the slot 37. To remove the showering device 10 from its support 22, it is simply required to remove one of the locking mechanisms 34 and pull on the other extremity of the showering device 10. Conveniently, because the hose 24 is made of a flexible material, removing the showering device 10 from its support 22 requires much less space than with the rigid showering devices of the prior art, as the showering device 10 may be rolled on itself as depicted in FIG. 4 and similarly to a firefighter hose. Advantageously, the showering device 10 of the present invention is also lighter than most showering devices of the prior art, thereby allowing only one person to perform the removal.

Alternatively, the support 22 may not run the whole width of the machine. It may be formed of two aligned half-supports proximate each side of the machine. These half-supports may even be fixed directly to a frame of the machine. When this type of support is used, the showering device 10 may be put under tension by tightening the nut 36 against each extremities of the support 22 (corresponding to the exterior extremities of each half-support) so that it stays substantially straight between the half-supports.

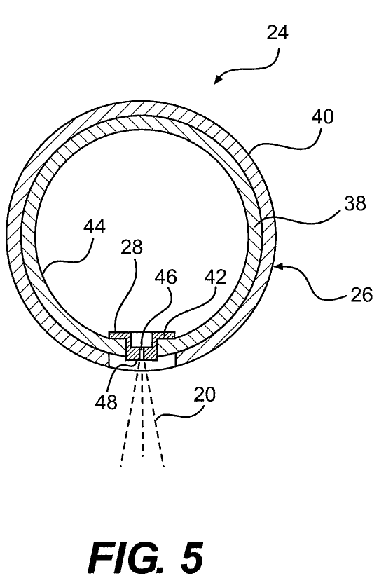

Turning now to FIG. 5, there is depicted a cross-section of the hose 24 showing that the hose wall 26 may be made of, amongst many different types of constructions, an internal layer 38 and an external layer 40. Although different solutions may be used, the internal layer 38 may have its inner face 44 coated with a product to render it impervious to the cleaning liquid. Typically, both layers are made of braided fibers. The hose diameter typically ranges from 2″ to 6″, although smaller or larger sizes may be used. The hose 24 should be pressure resistant to at least 250 psi or to any design-specific required pressure. For example, higher pressure resistance of up to 650 psi may be required for specific applications.

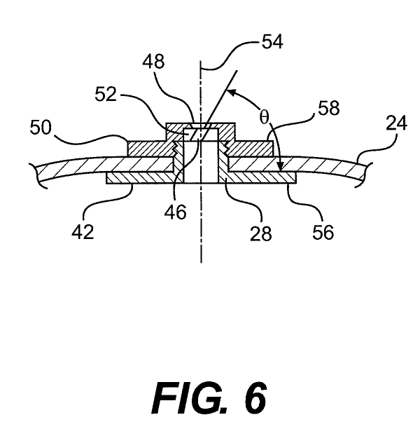

The nozzles 28 used in the showering device 10 may be of different designs. In an example of nozzle design, the nozzle 28 has a flange 42 for contacting the hose wall 26, more particularly an inner face 44 of the wall 26. The nozzle also has an orifice 46 located in an area of a nozzle outlet 48. This orifice 46 typically has a precise diameter. Typically, an adhesive is used to fix the flange 42 to the wall 26. Alternatively, as shown in FIG. 6, a mechanical means of fixing the nozzle 28 to the wall 26 could be used. For example, the wall 26 could be sandwiched between the flange 42, located on the inside of the wall 26 and an outside flange 50 mechanically fastened to the nozzle 28. This embodiment is depicted in FIG. 6, now concurrently referred to.

Water jets are very abrasive and tend to wear the orifice 46 of the nozzles 28, even though the nozzles are typically made of stainless steel. For superior wear resistance, the nozzles 28 may use a man made synthetic gem 52 such as a ruby. Such gems are more wear resistant than stainless steel. The gem 52 has an orifice 46 of precise dimension and is placed at the nozzle outlet 48 to provide an accurate and powerful jet.

Optionally, instead of being oriented normal to the flange 42, the orifice 48 may be disposed at a different orifice angle θ so that the jet, once the showering device is installed in the support of the papermaking machine, is aligned properly with a see-through angle of a mesh of the belt 14 (now shown in FIG. 6). Advantageously, this orifice angle θ may be adjusted by changing the gem 52 and may be oriented properly by rotating the nozzle 28 around its outlet axis 54.

Optionally, the nozzles 28 may be made of two parts, a first part 56 that comprises the flange 42 and that stays fixed to the hose 24, and a second part 58, containing the nozzle outlet 48, that can be replaced. The second part may be removably fixed to the first part by various methods such as by a quick-connect mechanism or by threads.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description. The invention is defined by the claims that follow.

I claim:

1. A hose for a showering device for cleaning a papermaking machine with a liquid, the hose comprising:
a flexible wall for circulating the liquid; and
a plurality of nozzles attached to said wall, said nozzles being substantially aligned together along a longitudinal axis of said hose, said nozzles being spaced apart, said nozzles connecting an interior side of said wall to an exterior side of said wall and allowing to spray the liquid.

2. A showering device for cleaning a papermaking machine with a liquid, the device comprising:
the hose of claim 1; and
two connectors, each one of said two connectors being placed at a different extremity of said hose.

3. The device of claim 2 further comprising two locking mechanisms, each one of said two locking mechanism being located proximate a respective one of said two connectors.

4. The device of claim 3 wherein at least one of said two locking mechanisms is removable from said connector.

5. The device of claim 2 wherein said at least one of said two connectors has an alignment mechanism aligned with said plurality of nozzles.

6. The device of claim 5 wherein said alignment mechanism is a mark.

7. The device of claim 5 wherein said alignment mechanism is a boss.

8. The device of claim 5 wherein said hose is capable of withstanding an internal pressure of at least 300 psi.

9. The device of claim 8 wherein said hose is capable of withstanding an internal pressure of at least 650 psi.

10. The device of claim 8 wherein said hose is made of an internal layer and an external layer, both layers being made of braided fibers.

11. The device of claim 10 wherein said inner face of said internal layer is impervious to liquid.

12. The device of claim 11 wherein each of said plurality of nozzles has a flange, said flange being in contact with said inner face.

13. The device of claim 12 wherein said nozzles have a nozzle outlet angle with respect to said flange that is less than 90 degrees.

14. The device of claim 12 wherein said nozzles comprise a gem.

15. The device of claim 14 wherein said gem is a ruby.

16. The device of claim 12 wherein said nozzles are made a first part and a second part, said first part containing said flange and being fixed to said hose, and said second part containing a nozzle outlet, said second part being removably fixed to said first part.
